(19) United States
(12) Patent Application Publication
(10) Pub. No.: US 2013/0207567 A1
(43) Pub. Date: Aug. 15, 2013

(54) BOOST CONVERTER ASSISTED VALLEY-FILL POWER FACTOR CORRECTION CIRCUIT

(71) Applicant: Alexander Mednik, Campbell, CA (US)

(72) Inventor: Alexander Mednik, Campbell, CA (US)

(21) Appl. No.: 13/475,019

(22) Filed: May 18, 2012

Related U.S. Application Data
(60) Provisional application No. 61/598,543, filed on Feb. 14, 2012.

(51) Int. Cl. H05B 41/282; G05F 1/70

(52) U.S. Cl. 315/247; 323/207

(57) ABSTRACT

A Light Emitting Diode (LED) lighting circuit has a passive valley-fill type power factor correction (PFC) circuit. A boost converter stage is coupled to the PFC circuit.

### RELATED APPLICATION

The present patent application is related to U.S. Provisional Application Ser. No. 61/598,543, filed Feb. 14, 2012, in the name of the same inventor listed above, and entitled, “BOOST Converter Assisted Valley-Fill Power Factor Correction Circuit”. The present patent application claims the benefit under 35 U.S.C. §119(e).

### BACKGROUND

The present invention relates generally to a Light Emitting Diodes (LEDs) and, more specifically, to a passive valley-fill Power Factor Correction (PFC) circuit that provides an improved Power Factor (PF).

Recent developments of high-brightness light emitting diodes (LED) have opened new horizons in lighting. Highly efficient and reliable LED lighting continuously wins recognition in various areas of general lighting, especially in areas where cost of maintenance is a concern.

Passive valley-fill power factor correction (PFC) circuits are commonly used in lighting ballasts to improve the input power factor (PF). Referring now to FIG. 1, a basic prior-art valley-fill PFC circuit is shown. The circuit of FIG. 1 receives AC mains power from an AC source 101 and delivers DC voltage to the load 100. The circuit of FIG. 1 consists of a bridge rectifier 102, energy storage capacitors 108 and 109, and commutating diodes 110, 111 and 112. Power factor is defined as the ratio between the active power drawn from the AC source 101 and the product of its AC current and voltage.

The circuit shown in FIG. 1 can achieve power factors ranging from approximately 0.70˜0.85. The typical waveforms of current 202 and voltage 201 in the AC source 101 are shown in FIG. 2.

Referring now to FIG. 3, an improved prior-art valley-fill PFC circuit is shown. The circuit of FIG. 3 is similar to that shown in FIG. 1. The circuit shown in FIG. 3 may be able to achieve power factor close to 0.9 by addition of a resistor 118 in series with the commutating diode 110. The fundamental deficiency of the circuit in FIG. 3 still remains: it does not address the current dropouts in the AC source 101 around zero crossings of its voltage. The improvement is also limited by power dissipation in the resistor 118.

The passive PFC circuits of FIGS. 1 and 3 are attractive due to their high efficiency and low cost. However, a power factor greater than 0.9 is typically needed for modern general lighting applications such as ones employing high-brightness light-emitting diodes (LED).

Therefore, it would be desirable to provide a circuit and method that overcomes the above problems.

### SUMMARY

A Light Emitting Diode (LED) lighting circuit has a passive valley-fill power factor correction (PFC) circuit. A boost converter stage is coupled to the PFC circuit.

A Light Emitting Diode (LED) lighting circuit has a passive valley-fill power factor correction (PFC) circuit. A boost converter stage is coupled to the PFC circuit. The boost converter stage comprises a boost element coupled to an input of the PFC circuit. A control switch coupled to the boost element. A control circuit is coupled to the control switch, wherein the control circuit comprises a current sense element which detects current flow in energy storage devices of the PFC circuit; and a switching modulator circuit for driving the control switch.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a prior art passive valley-fill power factor correction (PFC) circuit;

FIG. 2 shows typical waveforms of current and voltage in the AC source used in FIG. 1;

FIG. 3 is another prior art PFC circuit;

FIG. 4 is a circuit diagram showing a PFC circuit of the present invention;

FIG. 5 is a circuit diagram showing another embodiment of the PFC circuit of the present invention;

FIG. 6 is a circuit diagram showing one implementation of the PFC circuit shown in FIG. 5;

FIG. 7 shows waveforms of current and voltage for the circuit of FIG. 6; and

FIG. 8 is a circuit diagram showing another implementation of the PFC circuit shown in FIG. 5.

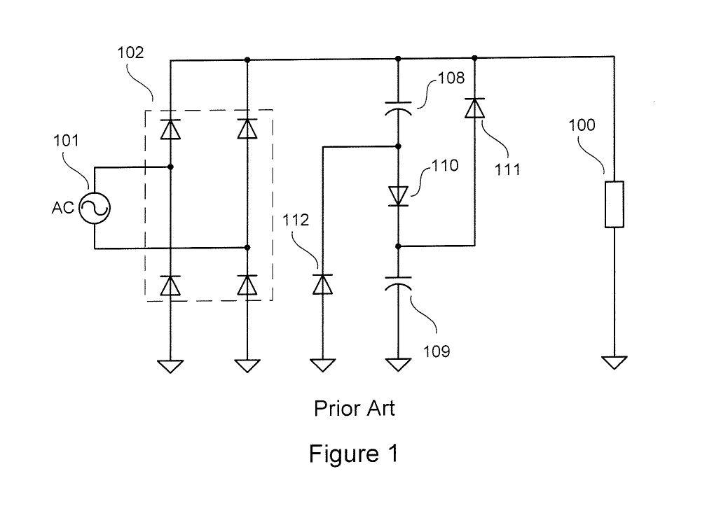

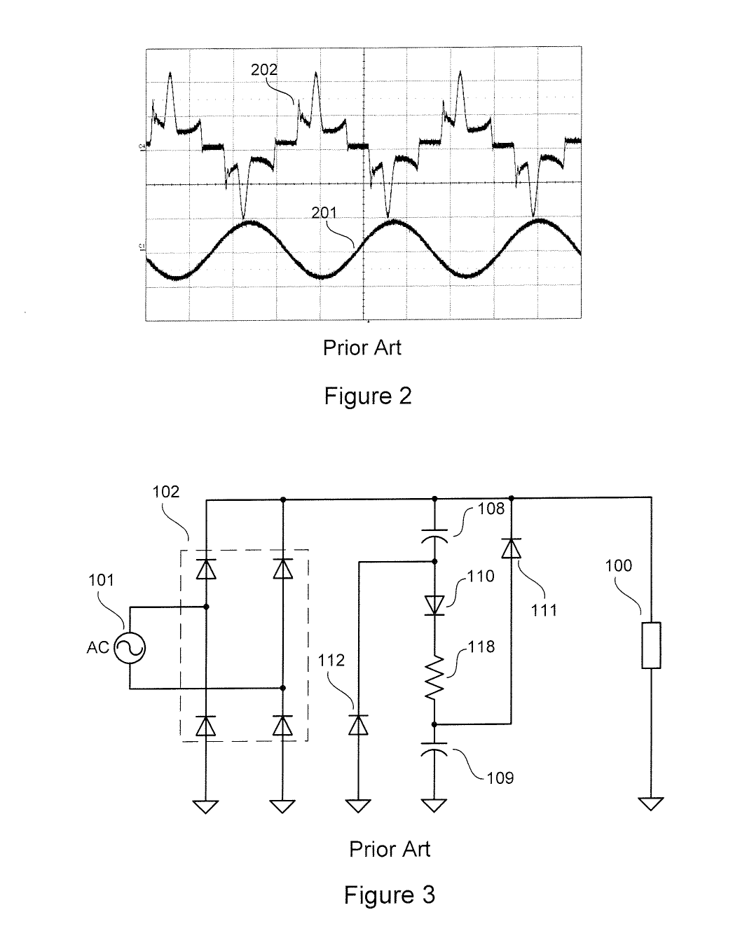

### DETAILED DESCRIPTION

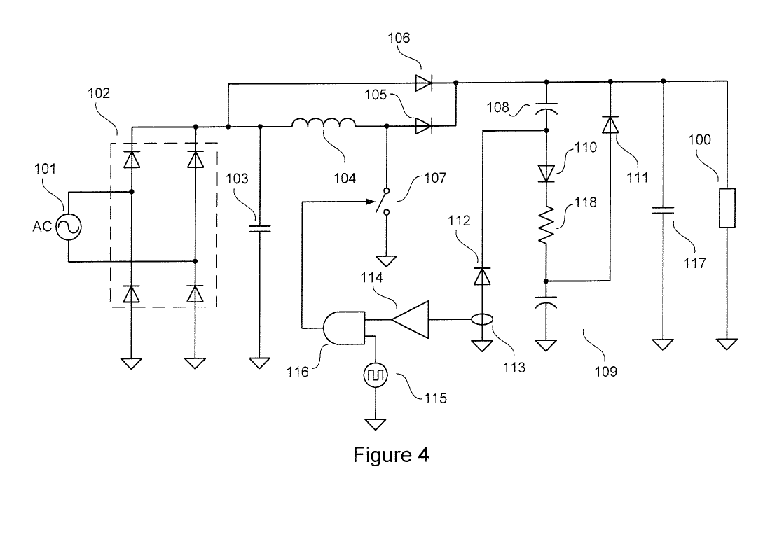

Referring now to FIG. 4, a generalized PFC circuit of the present invention is shown. The PFC circuit of FIG. 4 may be similar to the circuit of FIG. 3. The PFC circuit of FIG. 4 may receive AC mains power from an AC source 101 and delivers DC voltage to the load 100. The circuit of FIG. 4 consists of a bridge rectifier 102, energy storage capacitors 108 and 109, and commutating diodes 110, 111 and 112. A resistor 118 in series with the commutating diode 110 may be coupled to the energy storage capacitor 108 or 109.

The circuit of FIG. 4 may further include a boost converter stage. The boost converter stage may allow the circuit of FIG. 4 to generate a power factor greater than 0.9. The boost converter stage may comprise a boost inductor 104, a controlled switch 107, a boost diode 105, an input smoothing capacitor 103, and an output smoothing capacitor 117. The boost stage is bypassed by a diode 106. The circuit of FIG. 4 may also comprise a control circuit of the switch 107 consisting of a current sense element 113, a detector circuit 114 detecting presence of positive-polarity current in the capacitors 108-109, a switching modulator circuit for driving the switch 107 on and off at a high frequency rate, and a gate circuit 116 gating the drive signal 115 to the switch 107 when the positive-polarity current in the capacitors 108-109 is detected.

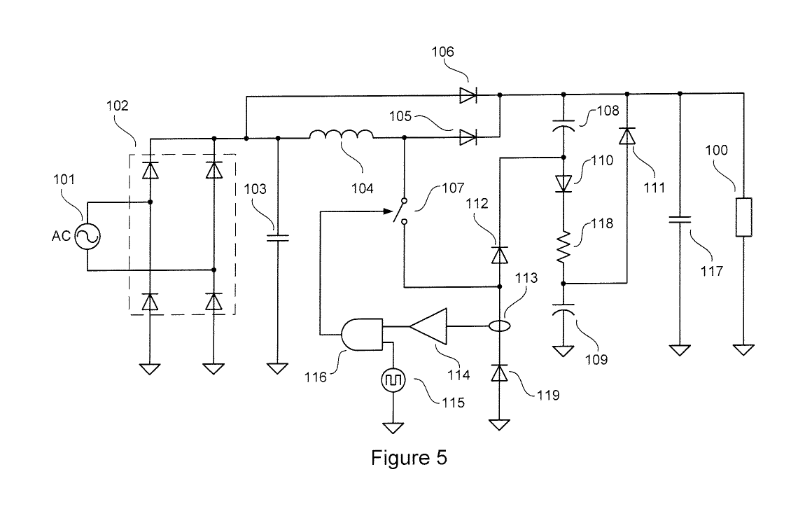

Referring now to FIG. 5, another embodiment of the circuit of the present invention is shown. The circuit of FIG. 5 is similar to that shown in FIG. 4. However, in addition to the elements of the circuit of FIG. 4, the circuit of FIG. 5 may further include a blocking diode 119 in series with the diode 112, wherein the switch 107 is connected at the common node of the diodes 112 and 119. In this circuit, current in the switch 104 is limited by the positive-polarity current in the capacitors 108-109.

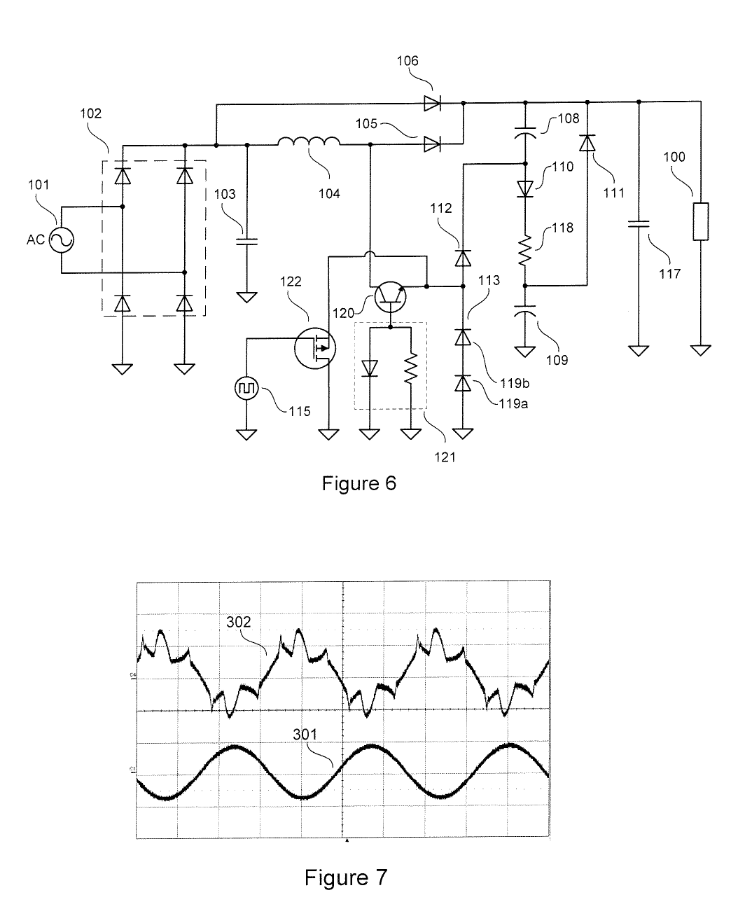

One possible implementation of the circuit of FIG. 5 is shown in FIG. 6. The switch 107 is replaced by a bipolar junction transistor 120 with its base drive circuit 121. The diode 119 consisting of multiple series-connected diodes 119a, 119b also serves the function of the current sense 113 and the detector 114. A MOSFET 122 serves a function of the gate circuit 116 driving the transistor 120 at the switching frequency rate of 115 when the diodes 119a and 119b are forward-biased. The boost stage therefore draws input current near the zero crossings of the input AC voltage 101, effectively filling in the dropouts of the input current inherent to the prior-art valley-fill circuits. The boost converter stage does not affect operation of the valley-fill circuit outside these dropouts.

Thus, the circuits of the present invention improve power factor and harmonic distortion of the input AC current without significant reduction in the overall power efficiency. The typical voltage 301 and current 302 waveforms of the PFC circuit of FIG. 6 are shown in FIG. 7. The circuit achieves power factor significantly greater than 0.9, as well as low harmonic distortion of the input AC current 302.

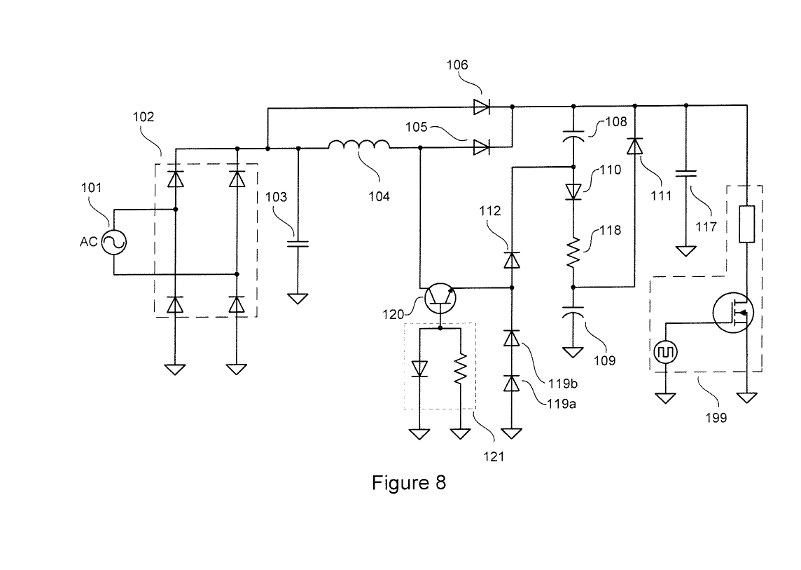

Another possible implementation of the circuit of FIG. 5 is shown in FIG. 8. The circuit of FIG. 8 is similar to that in FIG. 6. When the load 100 is a switching converter 199, diodes 119a and 119b conduct pulsed input current of the converter 199. Therefore, the switch 122 of FIG. 6 may be eliminated.

While embodiments of the disclosure have been described in terms of various specific embodiments, those skilled in the art will recognize that the embodiments of the disclosure can be practiced with modifications within the spirit and scope of the claims.

What is claimed is:

1. A power factor correction circuit comprising:
a passive valley-fill type power factor correction (PFC) circuit; and
a boost converter stage coupled to the PFC circuit.

2. The circuit of claim 1, wherein the boost converter stage comprises:
a boost element coupled to an input of the PFC circuit;
a control switch coupled to the boost element; and
a control circuit coupled to the control switch.

3. The circuit of claim 2, wherein the boost converter stage further comprising:
an input smoothing capacitor coupled to an input of the PFC circuit; and
an output smoothing capacitor coupled to an output of the PFC circuit.

4. The circuit of claim 2, wherein the boost element comprises a boost inductor coupled to the input of the PFC circuit.

5. The circuit of claim 4, wherein the boost element further comprises a boost diode coupled to the boost inductor.

6. The circuit of claim 5, wherein the boost converter stage further comprising:
an input smoothing capacitor coupled to an input of the PFC circuit; and
an output smoothing capacitor coupled to an output of the PFC circuit.

7. The circuit of claim 2, wherein the control circuit comprises a current sense element which detects current flow in energy storage devices of the PFC circuit.

8. The circuit of claim 7, wherein the control circuit further comprises a switching modulator circuit for driving the control switch.

9. The circuit of claim 7, wherein the control circuit makes use of pulsating current flow detected by the current sense element for driving the control switch.

10. The circuit of claim 8, wherein the switching modulator circuit comprises:
a gate circuit having a first input coupled to the current sense element and an output coupled to the control switch; and
a switching frequency signal coupled to a second input coupled to the gate circuit.

11. The circuit of claim 1, wherein the boost converter stage further comprises a bypass diode coupled between an input of the PFC circuit and an output of the PFC circuit.

12. The circuit of claim 8, wherein the boost converter stage further comprises a blocking diode coupled to the current sense element, wherein the control switch is coupled to the blocking diode.

13. A power correction circuit comprising:
a passive valley-fill type power factor correction (PFC) circuit; and
a boost converter stage coupled to the PFC circuit, wherein the boost converter stage comprises:
a boost element coupled to an input of the PFC circuit;
a control switch coupled to the boost element; and
a control circuit coupled to the control switch, wherein the control circuit comprises:
a current sense element which detects current flow in energy storage devices of the PFC circuit; and
a switching modulator circuit for driving the control switch.

14. The circuit of claim 13, wherein the boost converter stage further comprises:
an input smoothing capacitor coupled to an input of the PFC circuit; and
an output smoothing capacitor coupled to an output of the PFC circuit.

15. The circuit of claim 13, wherein the boost element comprises a boost inductor coupled to the input of the PFC circuit.

16. The circuit of claim 15, wherein the boost element further comprises a boost diode coupled to the boost inductor.

17. The circuit of claim 13, wherein the switching modulator circuit comprises:
a gate circuit having a first input coupled to the current sense element and an output coupled to the control switch; and
a switching frequency signal coupled to a second input coupled to the gate circuit.

18. The circuit of claim 13, wherein the boost converter stage further comprises a bypass diode coupled between an input of the PFC circuit and an output of the PFC circuit.

19. The circuit of claim 13, wherein the boost converter stage further comprises a blocking diode coupled to the current sense element, wherein the control switch is coupled to the blocking diode.

20. A circuit comprising:
a passive valley-fill type power factor correction (PFC) circuit; and
a boost converter stage coupled to the PFC circuit, wherein the boost converter stage comprises:
an input smoothing capacitor coupled to an input of the PFC circuit;
an output smoothing capacitor coupled to an output of the PFC circuit;
a control switch coupled to the boost element, wherein the boost element comprises:
a boost inductor coupled to the input of the PFC circuit;
a boost diode coupled to the boost inductor;
a control circuit coupled to the control switch, wherein the control circuit comprises:
a current sense element which detects current flow in energy storage devices of the PFC circuit;
a bypass diode coupled between an input of the PFC circuit and an output of the PFC circuit; and
a switching modulator circuit for driving the control switch.

21. The LED lighting circuit of claim 20, wherein the switching modulator circuit comprises:
a gate circuit having a first input coupled to the current sense element and an output coupled to the control switch; and
a switching frequency signal coupled to a second input coupled to the gate circuit.

22. The LED lighting circuit of claim 20, further comprising a blocking diode coupled to the current sense element, wherein the control switch is coupled to the blocking diode.

23. A passive valley-fill type power factor correction (PFC) circuit comprises:
a boost converter stage coupled to the PFC circuit.

24. The passive valley-fill type power factor correction (PFC) circuit of claim 23 further comprising a load coupled to the boost converter stage.

25. The passive valley-fill type power factor correction (PFC) circuit of claim 24 wherein the load comprises a switching converter, and wherein pulsating current of the load is used to drive the boost converter stage.
